(19) United States
(12) Patent Application Publication
(10) Pub. No.: US 2007/0008918 A1
(43) Pub. Date: Jan. 11, 2007

(54) Application layer presentation of routing and link quality data adapted for use in controlling movement of moveable devices

(75) Inventor: Peter J. Stanforth, Winter Springs, FL (US)

Correspondence Address: GARDNER CARTON & DOUGLAS LLP;(MESHNETWORKS/MOTOROLA) ATTN: PATENT DOCKET DEPT., 191 NORTH WACKER DRIVE, SUITE 3700, CHICAGO, IL, 60606-1698, US

(73) Assignee: MeshNetworks, Inc., Maitland, FL (US)

(21) Appl. No.: 11/176,990

(22) Filed: Jul. 8, 2005

(51) Int. Cl. H04Q 7/00

(52) U.S. Cl. 370/328; 455/456.1

(57) ABSTRACT

A wireless movable device, a system comprising the movable device, and a method for operating the movable device, wherein the movable device determines the link and channel quality of a link between itself and an ad-hoc device, such that the movable device is adapted to determine when it has traveled too far from the ad-hoc device to maintain a reliable link to the ad-hoc device, and wherein the movable device, upon determining the loss of a reliable link to the ad-hoc device, seeks out a location at which a reliable link exists with the ad-hoc device or with another ad-hoc device.

### BACKGROUND OF THE INVENTION

1. Field of the Invention

The present invention relates to a system and method for forming an ad-hoc multihopping network of movable devices. The present invention utilizes the knowledge of channel and link quality at the application layer to enable a movable device to create connections with other movable devices and to maintain reliable connections with the other movable devices in an autonomous and heuristic fashion. More particularly, the system and method comprise ad hoc radios in a network of movable devices, to which is presented routing and link quality data at the application layer.

2. Description of the Related Art

Wireless communication networks, such as mobile wireless telephone networks, have become increasingly prevalent over the past decade. These wireless communications networks are commonly referred to as “cellular networks”, because the network infrastructure is arranged to divide the service area into a plurality of regions called “cells”. A terrestrial cellular network includes a plurality of interconnected base stations, or base nodes, that are distributed geographically at designated locations throughout the service area. Each base node includes one or more transceivers that are capable of transmitting and receiving electromagnetic signals, such as radio frequency (RF) communications signals, to and from mobile user nodes, such as wireless telephones, located within the coverage area. The communications signals include, for example, voice data that has been modulated according to a desired modulation technique and transmitted as data packets. As can be appreciated by one skilled in the art, network nodes transmit and receive data packet communications in a multiplexed format, such as time-division multiple access (TDMA) format, code-division multiple access (CDMA) format, or frequency-division multiple access (FDMA) format, which enables a single transceiver at a first node to communicate simultaneously with several other nodes in its coverage area.

In recent years, a type of mobile communications network known as an “ad-hoc” network has been developed. In this type of network, each mobile node is capable of operating as a base station or router for the other mobile nodes, thus eliminating the need for a fixed infrastructure of base stations.

More sophisticated ad-hoc networks are also being developed which, in addition to enabling mobile nodes to communicate with each other as in a conventional ad-hoc network, further enable the mobile nodes to access a fixed network and thus communicate with other mobile nodes, such as those on the public switched telephone network (PSTN), and on other networks such as the Internet. Details of these advanced types of ad-hoc networks are described in U.S. patent application Ser. No. 09/897,790 entitled “Ad Hoc Peer-to-Peer Mobile Radio Access System Interfaced to the PSTN and Cellular Networks”, filed on Jun. 29, 2001, in U.S. patent application Ser. No. 09/815,157 entitled “Time Division Protocol for an Ad-Hoc, Peer-to-Peer Radio Network Having Coordinating Channel Access to Shared Parallel Data Channels with Separate Reservation Channel”, filed on Mar. 22, 2001, and in U.S. patent application Ser. No. 09/815,164 entitled “Prioritized-Routing for an Ad-Hoc, Peer-to-Peer, Mobile Radio Access System”, filed on Mar. 22, 2001, the entire content of each being incorporated herein by reference.

An application of wireless communication technology which has been the focus of much research is movable devices and, more particularly, robotics. In particular, for example, search and rescue robots are being developed for public safety and for homeland security. Moreover, researchers have focused, for example, on the practical limitations of movable devices that move away from a control point and, ultimately, can face unreliable radio links. In this regard, conventional movable devices can fall out of working range of a control station and lose communications with the control station when Line Of Sight (LOS) is lost between the movable device and the control station. Current routing and link layer implementations, in this regard, do not have enough information to perform adequately in all situations.

Accordingly, there remains a need for a system or method of deploying a movable ad hoc device network which presents routing and link quality data to the application layer.

### BRIEF DESCRIPTION OF THE DRAWINGS

These and other objects, advantages and novel features of the invention will be more readily appreciated from the following detailed description when read in conjunction with the accompanying drawings, in which:

FIG. 1 is a block diagram of an example ad-hoc wireless communications network including a plurality of nodes employing a system and method in accordance with an embodiment of the present invention;

FIG. 2 is a block diagram illustrating an example of a mobile node employed in the network shown in FIG. 1;

FIG. 3 is a diagram illustrating a first robot moving away from a control point to a point where it is out-of-range of the control point;

FIG. 4 is a diagram illustrating a second robot moving beyond the range of a control point and using the first robot of FIG. 3 as a relay or repeater;

FIG. 5 is a diagram illustrating the second robot of FIG. 4, moving out-of-range of the first robot of FIG. 3;

FIG. 6 is a diagram illustrating a manner in which the first robot of FIG. 3 backs up, in order to maintain a reliable link to both the control point and the second robot of FIG. 4, in accordance with an embodiment of the present invention; and

FIG. 7 is a diagram illustrating a series of four stack diagrams: a classic Open System Interconnection (OSI) model, an 802.11 ad-hoc model, a stack having a routing layer embedded under a network layer, and a stack in accordance with an embodiment of the present invention.

### DETAILED DESCRIPTION OF THE PREFERRED EMBODIMENTS

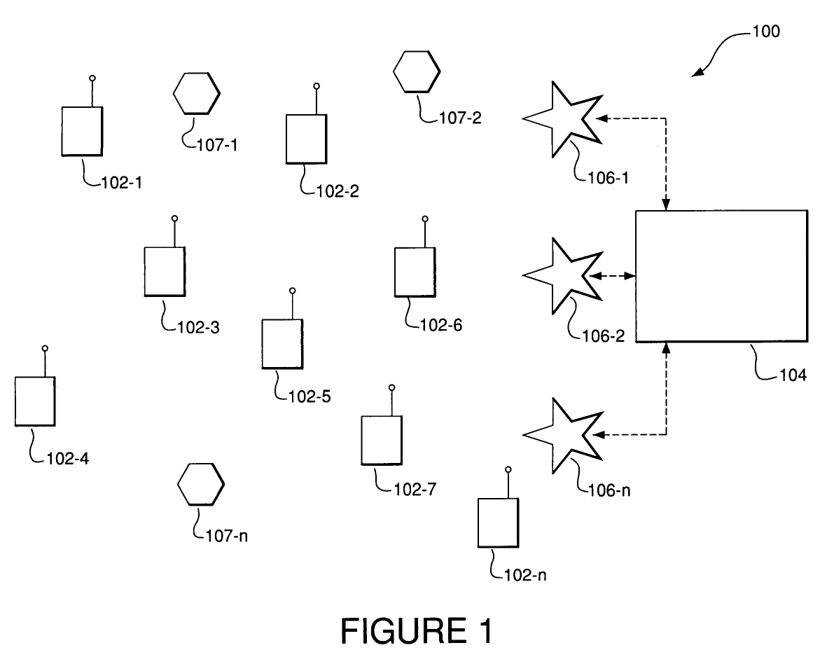

FIG. 1 is a block diagram illustrating an example of an ad-hoc packet-switched wireless communications network 100 employing an embodiment of the present invention. Specifically, the network 100 includes a plurality of mobile wireless user terminals 102-1 through 102-n (referred to generally as nodes 102 or mobile nodes 102), and can, but is not required to, include a fixed network 104 having a plurality of intelligent access points (IAPs) 106-1, 106-2, . . . 106-n (referred to generally as nodes 106, access points or IAPs 106), for providing nodes 102 with access to the fixed network 104. The fixed network 104 can include, for example, a core local access network (LAN), and a plurality of servers and gateway routers to provide network nodes with access to other networks, such as other ad-hoc networks, the public switched telephone network (PSTN) and the Internet. The network 100 further can include a plurality of fixed routers 107-1 through 107-n (referred to generally as nodes 107 or fixed routers 107) for routing data packets between other nodes 102, 106 or 107. It is noted that for purposes of this discussion, the nodes discussed above can be collectively referred to as “nodes 102, 106 and 107”, or simply “nodes”.

As can be appreciated by one skilled in the art, the nodes 102, 106 and 107 are capable of communicating with each other directly, or via one or more other nodes 102, 106 or 107 operating as a router or routers for packets being sent between nodes, as described in U.S. patent application Ser. Nos. 09/897,790, 09/815,157 and 09/815,164, referenced above.

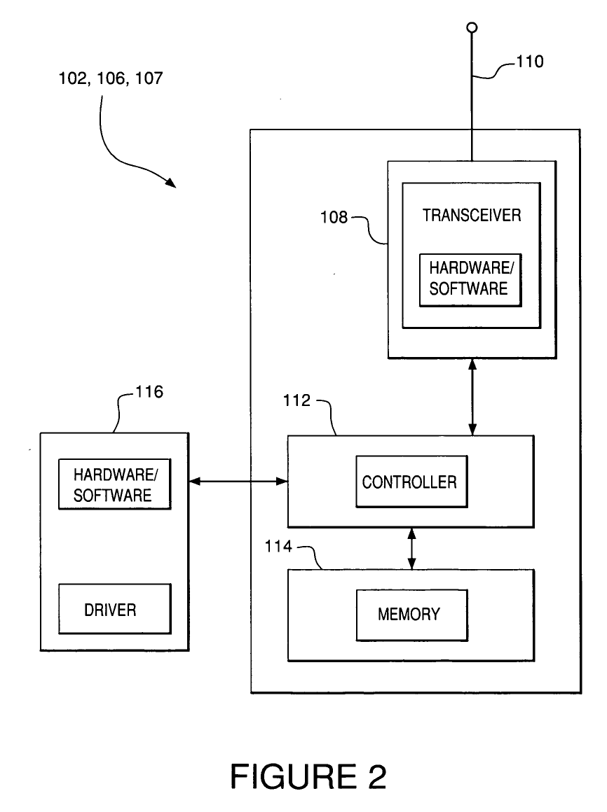

As shown in FIG. 2, each node 102, 106 and 107 includes a transceiver, or modem 108, which is coupled to an antenna 110 and is capable of receiving and transmitting signals, such as packetized signals, to and from the node 102, 106 or 107, under the control of a controller 112. The packetized data signals can include, for example, voice, data or multimedia information, and packetized control signals, including node update information.

Each node 102, 106 and 107 further includes a memory 114, such as a random access memory (RAM) that is capable of storing, among other things, routing information pertaining to itself and other nodes in the network 100. As further shown in FIG. 2, certain nodes, especially mobile nodes 102, can include a host 116 which may consist of any number of devices, such as a notebook computer terminal, mobile telephone unit, mobile data unit, or any other suitable device. Each node 102, 106 and 107 also includes the appropriate hardware and software to perform Internet Protocol (IP) and Address Resolution Protocol (ARP), the purposes of which can be readily appreciated by one skilled in the art. The appropriate hardware and software to perform transmission control protocol (TCP) and user datagram protocol (UDP) may also be included.

The use of ad hoc radios in networks of movable devices has the potential to extend communications between devices in these networks, for example, by repeating or relaying the communications through intermediate nodes. Additionally, channel and link quality information can be used to enable a moveable device to create connections with other devices. “Movable devices”, in this regard, can be any robot, vehicle, instrumentality, or any other controllable device. For purposes of this description, the term “movable device” will be used.

As will now be discussed, the present invention provides a wireless movable device that determines the link and channel quality of a link between itself and another device, such as an ad-hoc multihopping device, such that the movable device is adapted to determine when it has traveled too far from the ad-hoc device to maintain a reliable link to the ad-hoc device, and wherein the movable device, upon determining the loss of a reliable link to the ad-hoc device, seeks out a location at which a reliable link exists with the ad-hoc device or with another ad-hoc multihopping device.

The present invention also provides a system of wireless movable devices. The system comprises, for example, a first movable device that is adapted to determine the link and channel quality of a link between the first movable device and a first ad-hoc multihopping device, such that the first movable device is capable of determining when it has traveled too far from the first ad-hoc device to maintain a reliable link to the first ad-hoc device. The first movable device, upon determining the loss of a reliable link to the first ad-hoc device, is adapted to seek out a location at which a reliable link exists with the first ad-hoc device or with another ad-hoc multihopping device, and stops at that location. A second movable device, having a link with the first movable device, determines the link and channel quality of a link between itself and the first movable device. The second movable device is capable of determining when it has traveled too far from the first movable device to maintain a reliable link to the first movable device. The second movable device, upon determining the loss of a reliable link to the first movable device, seeks out a location at which a reliable link exists with the first movable device or with another ad-hoc multihopping device, and stops at that location.

The present invention also provides a method for operating wireless movable devices, the method comprising: deploying a first movable device that is adapted to determine the link and channel quality of a link between itself and a first device, such as a first ad-hoc multihopping device. The first movable device is operated to determine when it has traveled too far from the first ad-hoc device to maintain a reliable link to the first ad-hoc device, and, when the first movable device determines the loss of a reliable link to the first ad-hoc device, the first movable device is operated to seek out a location at which a reliable link exists with the first ad-hoc device or with another ad-hoc multihopping device, and the first movable device is moved to that location.

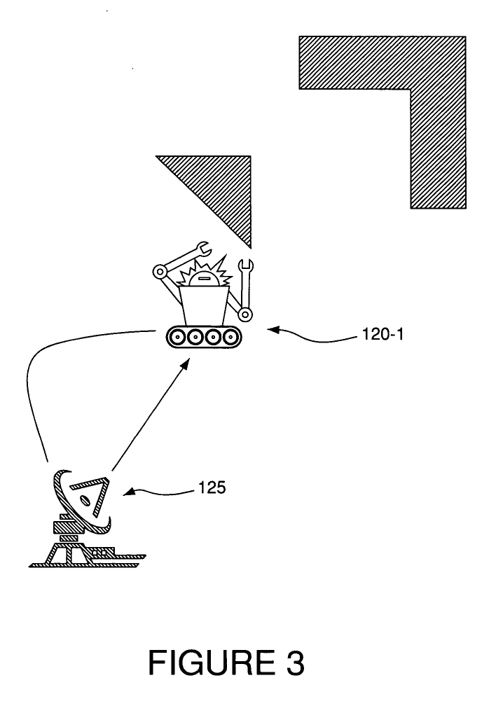

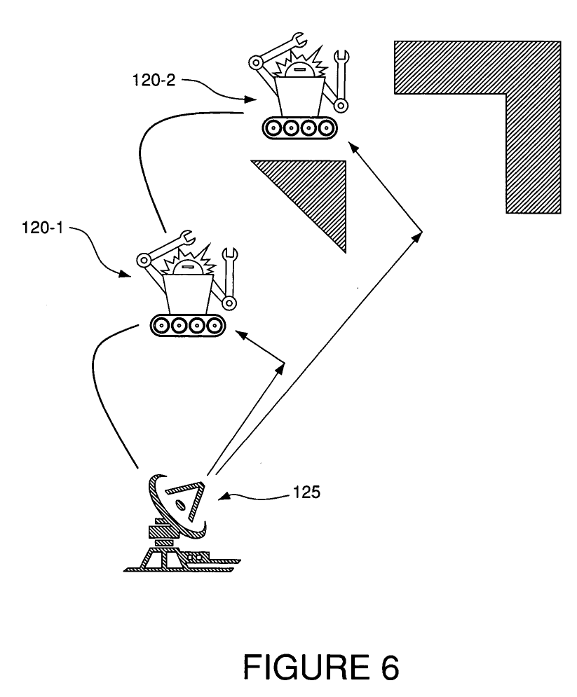

A network including movable device will be described with regard to FIGS. 3-7. As will be appreciated from the following, each of these movable devices includes one or more mobile nodes 102, and each controller can include one or more intelligent access points (IAPs) 106 of the type discussed above. It is also noted that each movable device can include a mobile IAP, as described in U.S. patent application Ser. No. 09/929,030, the entire contents of which is incorporated herein by reference.

FIG. 3 shows a network in which a deployable robot 120-1 is dependent on one or more control stations 125, it is preferable for the robot to capable of determining and recognizing if and when and at what point it has traveled too far or not far enough away from the control station. This is not a geographic issue, or necessarily an LOS issue, but an issue of the quality of the radio link between the robot 120-1 and the control station 125. Preferably, in this regard, when a first robot 120-1 reaches a point in its travels away from a control station 125 at which the robot 120-1 loses its good connection with the control station 125, as illustrated in FIG. 3, the robot 120-1 will travel back towards the control station 125 until it reaches a point where it regains its good connection with the control station 125, at which point the robot 120-1 will determine this location to be a stopping point, and will stop. This differs from conventional systems, in which the control point would have to retrieve the robot 120-1 or where the robot 120-1 stops before it has traveled completely out of range.

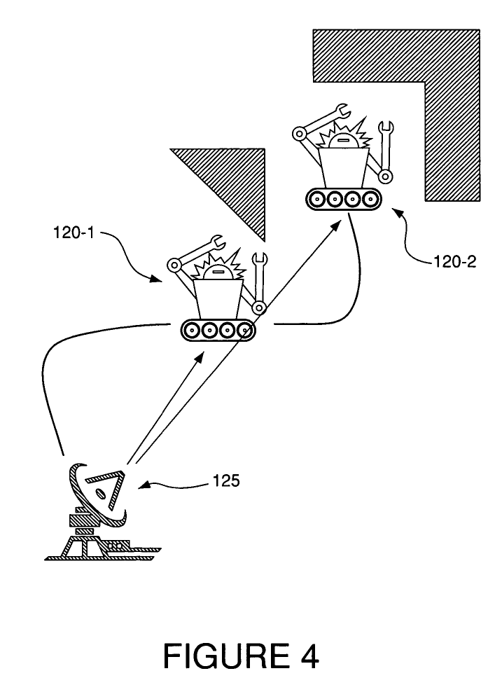

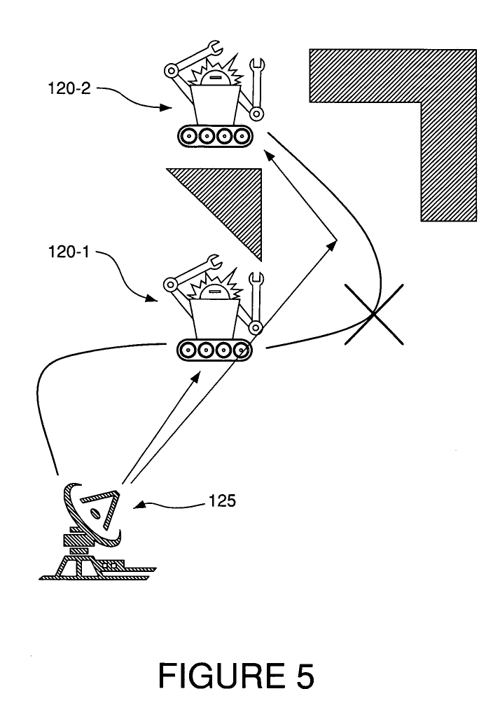

As illustrated in FIG. 4, a second robot 120-2 can keep traveling away from the control station 125, however, using the first robot 120-1 as an anchor, relay, repeater, or intermediate node, as discussed above with regard to FIG. 1. The second robot 120-2 can travel away from the first robot 120-1 until it reaches a point at which the second robot 120-2 loses its good connection with the first robot 120-1, as illustrated in FIG. 5. When this occurs, the second robot 120-2 travels backs towards the first robot 120-1 and stops at a point where it regains its good connection. In this regard, when the second robot 120-2 moves out-of-range of the first robot 120-1, there are two possibilities which are preferable. In a first embodiment, the second robot 120-2 backs up until a reliable link is obtained, and then a third robot can be dispatched to extend the range. In a second embodiment, the first robot 120-1 and second robot 120 2 both move in an attempt to obtain a better link to make progress. For instance, the first robot 120-1 can back up. By backing up, the robot 120-1 can reestablish a good link to both the control point 125 and the second robot 120-2 to allow further progress to be made. Moreover, still more robots can travel even further ahead of the second robot 120-2, in this same manner, using the second robot as a relay or repeater.

While the above-described scenario pertains to movable devices 120-1 seeking to stay in contact with a control station 125, it can clearly be extended to enable movable devices to find and maintain good quality links with other movable devices in a network. In a scenario in which a “swarm” of movable devices (e.g., robots) is searching a terrain, each movable device may have more than one option in terms of routes. Accordingly, it will not always be necessary for the movable devices to move to create a better communications link. Conversely, it may be necessary for several movable devices to move to create and maintain the communications network.

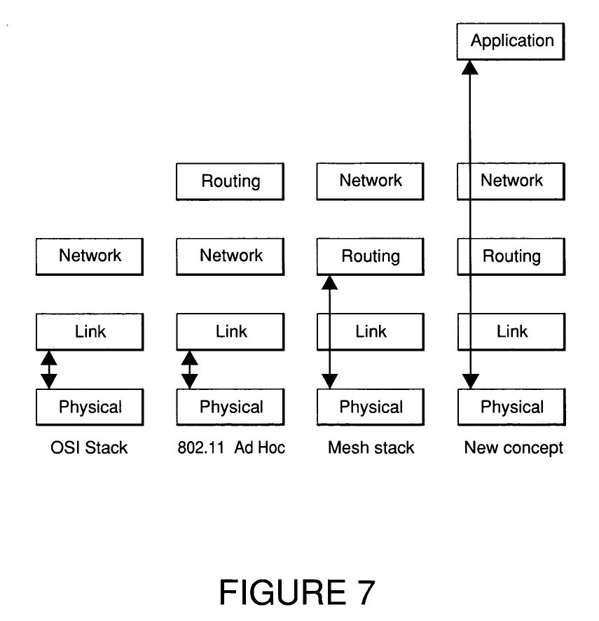

While conventional movable devices use link quality metrics in layer 2 and layer 3 of the stack, the present invention allows for the use of radio metrics in higher layers of the protocol stack. In this regard, any suitable sets of metrics can be provided or visible at the high layers utilized in the present invention, such as, for example, link quality, congestion, throughput, priority, and battery life. Moreover, any suitable algorithm can be employed at the high layers utilized in the context of the present invention so that the metrics can be more readily understood and acted upon by additional applications. FIG. 7 shows how this evolution works in the context of the classic OSI model. In the traditional model, the link layer and physical layer control the RF and little if any of this information is propagated up the stack. By design the higher layers are supposed to be independent of the lower layers. FIG. 7 further shows how this impacts ad hoc routing for a protocol like 802.11. Preferably, routing is embedded under the network layer so that the routing can make use of physical layer information available at the MAC. Most preferably, this information should be propagated up the stack to the application layers to provide the complex scenarios described above.

“Intelligent” radios can also be used in the context of the present invention. In particular, as technology allows the devices to change the modulation and bandwidth on the fly, the devices can start to add application layer considerations that are not possible with the limited knowledge that is available at the lower layers in the stack. For instance, a movable device may be going out of range where it can maintain a high speed data link. An option to maintain the link would be to change the modulation to a lower data rate. However, it may be possible for the mobile device to look to the option of acquiring more bandwidth in order to maintain the data rate with the lower modulation. This may require knowledge about the location and other spectrum users in the location, as well as the price of bandwidth, QOS constraints or other policy rules and regulations. Accordingly, it is advantageous to provide the additional information to the upper layers in the stack, so that such information can be readily access by additional applications.

Although only a few exemplary embodiments of the present invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

What is claimed is:

1. A wireless movable device that determines the quality of a link between itself and another device adapter for communication in an ad-hoc network, such that the movable device is adapted to determine when it has traveled too far from the other device to maintain a reliable link to the other device, and wherein the movable device, upon determining the loss of a reliable link to the other device, seeks out a location at which a reliable link exists with the other device or with a different device adapted for communication in the ad-hoc network.

2. The wireless movable device of claim 1, wherein the other device is a wireless movable device.

3. The wireless movable device of claim 1, wherein the movable device acts as an intermediate node between the other device and a second device adapted for communication in the ad-hoc network.

4. The wireless movable device of claim 1, wherein the quality of the link is based on at least one of link quality and channel quality.

5. The wireless movable device of claim 1, wherein information pertaining to at least one of the link quality and channel quality of the link between the movable device and the other device is presented to an application layer of the movable device for determination of the strength of the link.

6. The wireless movable device of claim 1, wherein the movable device is controllable by a remote user.

7. A system of wireless movable devices, the system comprising:
a first movable device that is adapted to determine the quality of a link between itself and a first other device adapted to communicate in an ad-hoc network, such that the first movable device is capable of determining when it has traveled too far from the first other device to maintain a reliable link to the first other device, and the first movable device, upon determining the loss of a reliable link to the first other device, is adapted to seek out a location at which a reliable link exists with the first other device or with a first different device adapted to communicate in the ad-hoc network; and
a second movable device adapted to establish a link with the first movable device, the second movable device being further adapted to determine the quality of a link between itself and the first movable device, and the second movable device is capable of determining when it has traveled too far from the first movable device to maintain a reliable link to the first movable device, such that the second movable device, upon determining the loss of a reliable link to the first movable device, seeks out a location at which a reliable link exists with the first movable device, the first different device or a second different device adapted to communicate in the ad-hoc network.

8. The system of claim 7, wherein the first other device is a wireless movable device.

9. The system of claim 9, wherein information pertaining to the quality of the link between the first movable device and the first other device is presented to an application layer of the first movable device for determination of the strength of the link.

10. The system of claim 9, wherein information pertaining to the quality of a link between the first movable device and the second movable device is also presented to the application layer of the first movable device for determination of the strength of that link.

11. The system of claim 7, wherein information pertaining to the quality of a link between the second movable device and the first movable device is presented to an application layer of the second movable device for determination of the strength of the link.

12. The system of claim 7, wherein the first movable device and the second movable device are controllable by a remote user.

13. A method for operating wireless movable devices, the method comprising:
deploying a first movable wireless device that is adapted to determine the quality of a wireless link between itself and a first other wireless device;
operating the first movable wireless device to determine when it has traveled too far from the first other wireless device to maintain a reliable wireless link to the first other device; and
when the first movable wireless device determines the loss of a reliable link to the first other wireless device, operating the first movable wireless device to seek out a location at which a reliable link exists with the first other wireless device or with another wireless device, and moving the first movable device to that location.

14. The method of claim 13, the method further comprising:
deploying a second movable wireless device to establish a wireless link with the first movable device;
operating the second movable wireless device to determine the quality of the link between itself and the first movable wireless device;
operating the second movable wireless device to determine when it has traveled too far from the first movable wireless device to maintain a reliable link to the first movable wireless device; and
when the second movable wireless device determines the loss of a reliable wireless link to the first movable wireless device, operating the second movable wireless device to a location at which a reliable link exists with the first movable wireless device, the first other wireless device or a second other wireless device, and moving the second movable device to that location.

15. The method of claim 13, wherein the first movable wireless device acts as an intermediate node between the first other wireless device and a second other wireless device.

16. The method of claim 13, wherein the first other wireless device is a wireless movable device.

17. The method of claim 13, wherein the first movable wireless device is adapted to communicate in a wireless ad-hoc network, and wherein information pertaining to the quality of a link between the first movable wireless device and the first other wireless device is presented to an application layer of the first movable wireless device for determination of the strength of the link.

18. The method of claim 14, wherein information pertaining to the quality of a link between the second movable wireless device and the first movable wireless device is presented to an application layer of the second movable wireless device for determination of the strength of the link.

19. The method of claim 14, wherein the first movable wireless device and the second movable wireless device are controllable by a remote user.

20. The method of claim 13, wherein:
the first movable wireless device and the first other wireless device are adapted to communicate with each other in an ad-hoc network.
